(19) United States
(12) Patent Application Publication
(10) Pub. No.: US 2008/0213571 A1
(43) Pub. Date: Sep. 4, 2008

(54) Sintered magnesium oxide, and plasma display panel prepared therefrom

(76) Inventors: Hee-Young Chu, Yongin-si (KR); Young-Su Kim, Yongin-si (KR); Soon-Sung Suh, Yongin-si (KR); Min-Suk Lee, Yongin-si (KR); Deok-Hyun Kim, Yongin-si (KR); Suk-Ki Kim, Yongin-si (KR); Jong-Seo Choi, Yongin-si (KR); Jae-Hyuk Kim, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/070,077

(22) Filed: Feb. 14, 2008

(30) Foreign Application Priority Data
Feb. 21, 2007 (KR) 10-2007-0017557

(51) Int. Cl. B32B 5/16; C01F 5/02; B22F 3/12; B32B 37/00

(52) U.S. Cl. 428/330; 423/635; 419/38; 156/60

(57) ABSTRACT

The sintered magnesium oxide according to one embodiment has a density of less than 3.5 g/cm³ and an average grain size of about 3 to about 10 μm. A MgO protective layer made from the sintered magnesium oxide reduces a discharge voltage of a plasma display panel, improves its response speed, and provides it with high-purity film quality.

### CROSS-REFERENCE TO RELATED APPLICATION

This application claims priority to and the benefit of Korean Patent Application No. 10-2007-0017557 filed in the Korean Intellectual Property Office on Feb. 21, 2007, the entire content of which is incorporated herein by reference.

### BACKGROUND OF THE INVENTION

1. Field of the Invention

The present embodiments relate to a sintered magnesium oxide, and a plasma display panel made by using the same. More particularly, the present embodiments relate to a sintered magnesium oxide for forming a MgO protective layer that reduces a discharge voltage of a plasma display panel, improves a response speed, and provides high-purity film quality.

2. Description of the Related Art

A plasma display panel (PDP) is a display device that forms an image by exciting a phosphor with vacuum ultraviolet (VUV) rays generated by gas discharge in discharge cells. Since a PDP is capable of realizing a large high-resolution screen, it has drawn attention as a next-generation thin display device.

PDPs are broadly classified into alternating current (AC) types and direct current (DC) types. The AC PDPs are the most widely used. The AC PDP has a basic structure where two electrodes are arranged to cross between two substrates that face each other and are filled with a discharge gas, and being partitioned by barrier ribs. One electrode is coated with a dielectric layer for generating wall charges, and the other electrode is disposed opposite thereto and coated with a phosphor layer.

On the dielectric layer, a protective layer that is generally composed of MgO is disposed.

The protective layer has sputtering resistance to compensate an affect due to ion bombardment of the discharge gas, while the plasma display panel is discharged. The protective layer is covered on the dielectric layer in the form of a transparent protective thin film having a thickness of 3000 to 7000 Å, which protects the dielectric layer from the ion bombardment and lowers the discharge voltage through the secondary emission of electrons.

Since the characteristics of the protective layer are widely varied depending upon the conditions of the depositing process, heat and the layer-forming process, it is hard to maintain display quality within a certain level. The protective layer may cause black noise due to an address discharge delay, which is an address miss in which light is not emitted in the selected cell. The black noise generally occurs in a boundary between a light-emitting region and no light-emitting region, but may occur at other regions. An address miss occurs at low intensity when there is no address discharge or even when a scan discharge has progressed. The present embodiments are effective in diminishing the address discharge delay time of PDPs as well as other advantages.

### SUMMARY OF THE INVENTION

One embodiment provides a sintered magnesium oxide for forming a MgO protective layer that can reduce a discharge voltage of a plasma display panel, improve response speed, and provide high-purity film quality. Another embodiment provides a method of preparing the sintered magnesium oxide. Yet another embodiment provides a plasma display panel including the sintered magnesium oxide.

According to one embodiment, provided is a sintered magnesium oxide that has a density of less than about 3.5 g/cm³ and an average grain size of about 1 to about 12 μm.

The average grain size may range from about 3 to about 10 μm.

The sintered magnesium oxide has a density of about 3.0 to about 3.49 g/cm³.

The magnesium oxide particles may be polycrystalline magnesium oxide having a particle diameter of about 10 to about 35 μm. The magnesium oxide particles may be monocrystalline magnesium oxide having a particle diameter of about 50 to about 500 nm.

According to another embodiment, provided is a plasma display panel that includes: a first substrate and a second substrate facing each other; a plurality of address electrodes disposed on the first substrate; a plurality of display electrodes disposed on one side of the second substrate facing the first substrate in a direction crossing the address electrodes; a phosphor layer disposed in the discharge spaces; a MgO protective layer formed from the sintered magnesium oxide while covering the display electrodes; a plurality of barrier ribs having a predetermined height from the first dielectric layer and disposed in a space between the first and second substrates to partition the space into discharge cells of a predetermined size; and a phosphor layer disposed in a discharge space.

### BRIEF DESCRIPTION OF THE DRAWINGS

FIG. 1 is a partially-exploded perspective view showing a plasma display panel according to one embodiment.

FIGS. 2A to 2D are scanning electron microscope (SEM) photographs of magnesium oxide particles prepared according to Example 1.

FIGS. 3A to 3D are scanning electron microscope (SEM) photographs of magnesium oxide particles prepared according to Example 2.

FIGS. 4A to 4D are scanning electron microscope (SEM) photographs of magnesium oxide particles prepared according to Example 3.

FIGS. 5A to 5D are scanning electron microscope (SEM) photographs of magnesium oxide particles prepared according to Comparative Example 1.

FIG. 6 is a scanning electron microscope (SEM) photograph of sintered magnesium oxide particles prepared according to Example 1.

FIG. 7 is a scanning electron microscope (SEM) photograph of sintered magnesium oxide particles prepared according to Example 2.

FIG. 8 is a scanning electron microscope (SEM) photograph of sintered magnesium oxide particles prepared according to Example 3.

FIG. 9 is a scanning electron microscope (SEM) photograph of sintered magnesium oxide particles prepared according to Comparative Example 1.

FIG. 10 is a graph showing discharge firing voltages of plasma display panels respectively including the sintered magnesium oxides according to Examples 1 to 3 and Comparative Example 1.

FIG. 11 is a graph showing statistic delay time (Tₛ) of the plasma display panels that respectively include the sintered magnesium oxides according to Example 2 and Comparative Example 1.

### DETAILED DESCRIPTION OF THE EMBODIMENTS

The sintered magnesium oxide according to one embodiment has a density of less than about 3.5 g/cm³ and an average grain size of about 1 to about 12 μm. The average grain size may range from about 3 to about 10 μm.

When a sintered magnesium oxide having an average grain size of about 1 to about 12 μm is formed onto a MgO protective layer, it can reduce the discharge voltage of a plasma display panel, improve its response speed, and provide high-purity film quality with the panel.

The sintered magnesium oxide is prepared by sintering magnesium oxide particles so that they can be adhered to one another and hardened. When a sintered magnesium oxide has an average grain size within the above range, the magnesium oxide particles therein may be sintered to be relatively loose. Accordingly, since the magnesium oxide particles included in the magnesium oxide have a weak bond and can thereby be easily evaporated even when they are treated with very small energy, it will take less time to form a MgO protective layer. In addition, when the magnesium oxide particles have a weak bond, they may be evaporated as a minimum unit and thereby have increased mobility in a MgO protective layer, which leads to stable growth of the MgO protective layer.

Furthermore, when the sintered magnesium oxide has an average grain size within the above range, there is small possibility that magnesium oxide particles can chemically react with moisture and impurities in a pore among the particles, which leads to preparation of a MgO protective layer with higher purity.

The sintered magnesium oxide can be measured regarding its average grain size through a scanning electron microscope (SEM). The average grain size can be measured by drawing a straight line in a maximum length direction of each grain and then averaging the measurements of the straight lines. Herein, the average grain size can be gained from at least 20 measurements.

The sintered magnesium oxide has a density of less than about 3.5 g/cm³. According to one embodiment, the sintered magnesium oxide has a density of about 3.0 to about 3.49 g/cm³. When the sintered magnesium oxide has a density of more than about 3.5 g/cm³, it may require too much energy for deposition.

The magnesium oxide particles may be a polycrystalline magnesium oxide having a particle diameter of from about 10 to about 35 μm. A polycrystalline magnesium oxide particle is a secondary particle of primary magnesium oxide particles that are adhered to one another. Accordingly, the diameter of the magnesium oxide particle indicates that of a secondary particle.

However, when polycrystalline magnesium oxide particles having a diameter from about 10 to about 35 μm are sintered to prepare a sintered magnesium oxide, they may not be well-sintered and thereby remain on the surface of the sintered magnesium oxide. Accordingly, it may have an average grain size ranging from about 1 to about 12 μm, but according to another embodiment, it may be in a range from about 3 to about 10 μm.

In addition, the magnesium oxide particle may have a diameter ranging from 50 to 500 nm, and may be a monocrystalline magnesium oxide particle. The monocrystalline magnesium oxide particle is a primary magnesium oxide particle, and also a cubic crystal.

Since the monocrystalline magnesium oxide particle having a diameter from about 50 to about 500 nm has stable crystal characteristics, it may have a small possibility of being chemically combined with impurities and moisture around it. In addition, since the magnesium oxide particles are not well-sintered to one another, they may remain on the surface of the sintered magnesium oxide having an average grain size ranging from 1 to 12 μm.

A method of preparing a sintered magnesium oxide by using polycrystalline magnesium oxide particles or the monocrystalline magnesium oxide particles will be explained. Specifically, magnesium oxide particle powders are mixed and dried, and then compressed to form a shape. Then, its crystals grow at a high temperature from about 1600 to about 1700° C.

According to another embodiment, provided is a plasma display panel that includes: a first substrate and a second substrate facing each other; a plurality of address electrodes disposed on the first substrate; a plurality of display electrodes disposed on one side of the second substrate facing the first substrate in a direction crossing the address electrodes; a phosphor layer disposed in the discharge spaces; a MgO protective layer formed from the sintered magnesium oxide while covering the display electrodes; a plurality of barrier ribs having a predetermined height from the first dielectric layer and disposed in a space between the first and second substrates to partition the space into discharge cells of a predetermined size; and a phosphor layer disposed in the discharge cell.

An embodiment will hereinafter be described in detail with reference to the accompanying drawings. However, the present embodiments can be realized in various different ways and is not limited to illustrated embodiments.

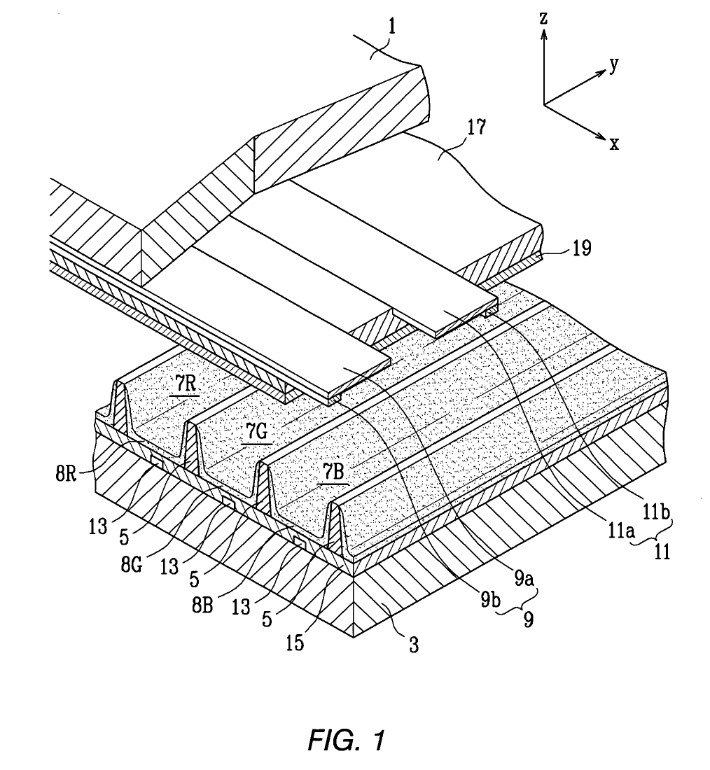

FIG. 1 is a partially-exploded perspective view showing the structure of a plasma display panel according to one embodiment. Referring to the drawing, the PDP includes a first substrate 3, a plurality of address electrodes 13 disposed in one direction (a Y direction in the drawing) on the first substrate 3, and a dielectric layer 15 disposed on the surface of the first substrate 3 covering the address electrodes 13. Barrier ribs 5 are formed on the dielectric layer 15, and red (R), green (G), and blue (B) phosphor layers 8R, 8G, and 8B are disposed in discharge cells 7R, 7G, and 7B formed between the barrier ribs 5.

The barrier ribs 5 may be formed in any shape as long as their shapes can partition the discharge space and also have diverse patterns. For example, the barrier ribs 5 may be formed as an open type such as stripes, or as a closed type such as a waffle, a matrix, or a delta shape. Further, the closed-type barrier ribs may be formed such that a horizontal cross-section of the discharge space is a polygon such as a quadrangle, a triangle, a pentagon, a circle or an oval.

Display electrodes, each including a pair of transparent electrodes 9a and 11a and bus electrodes 9b and 11b, are disposed in a direction crossing the address electrodes 13 (an X direction in the drawing) on one surface of a second substrate 1 facing the first substrate 3. Also, a dielectric layer 17 and a protective layer 19 are disposed on the surface of the second substrate 1 while covering the display electrodes.

The MgO protective layer is prepared by using a sintered magnesium oxide according to the present embodiments. A method of preparing the MgO protective layer with the sintered magnesium oxide may include a thick-layer printing method and a deposition method using plasma. The deposition method may have relatively strong resistance against sputtering by ion impact, and reduce a display voltage and a discharge firing voltage according to secondary electron emission.

The plasma deposition method of forming a protective layer may include magnetron sputtering, electron beam deposition, ion beam assisted deposition (IBAD), and a chemical vapor deposition (CVD) method, or an ion plating method and the like of forming a membrane by ionizing evaporated particles. The ion plating method may have similar characteristics to sputtering regarding a close contacting property and crystallinity of a MgO protective layer, but can be performed at a higher deposition speed of about 8 nm/s.

Discharge cells are formed at positions where the address electrodes 13 of the first substrate 3 are crossed by the display electrodes of the second substrate 1.

The first substrate 3 and the second substrate 1 are sealed under vacuum at their overlapped edge by a sealing glass, for example.

In the plasma display panel, address discharge is performed by applying an address voltage (Va) to a space between the address electrodes 13 and the display electrodes. When a sustain voltage (Vs) is applied to a space between a pair of display electrodes, an excitation source generated from the sustain discharge can excite a corresponding phosphor layer to thereby emit visible light through the second substrate 1 and display an image. The phosphors are usually excited by vacuum ultraviolet (VUV) rays.

The following examples illustrate the present embodiments in more detail. However, it is understood that the present embodiments are not limited by these examples.

### Preparation of a Sintered Magnesium Oxide

### Example 1

A sintered magnesium oxide was prepared by sintering polycrystalline magnesium oxide particles having a diameter ranging from 10 to 20 μm at 1700° C. for 11 hours.

### Example 2

A sintered magnesium oxide was prepared by sintering polycrystalline magnesium oxide particles having a diameter ranging from 15 to 35 μm at 1700° C. for 11 hours.

### Example 3

A sintered magnesium oxide was prepared by sintering monocrystalline magnesium oxide particles having a diameter ranging from 50 to 500 nm at 1700° C. for 11 hours.

### Comparative Example 1

A sintered magnesium oxide was prepared by the same method as in Example 1, except for using polycrystalline magnesium oxide particles having a diameter of 1 μm.

### Fabrication of a Plasma Display Panel (PDP)

An indium tin oxide conductor material was used to form a display electrode in a stripe shape on an upper substrate made of soda lime glass.

Next, a lead-based glass paste was coated over the upper substrate including the display electrode and fired to form a dielectric layer.

Then, the sintered magnesium oxide according to Examples 1 to 3 and Comparative Example 1 was ion-plated to form a MgO protective layer on the dielectric layer.

Examination of a Magnesium Oxide Particle with a Scanning Electron Microscope

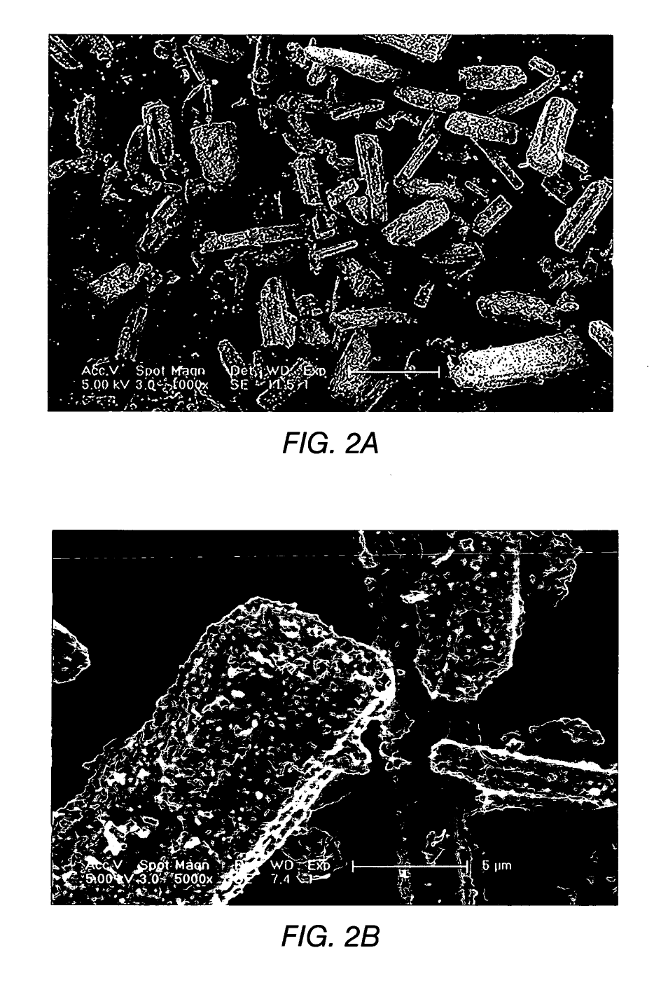

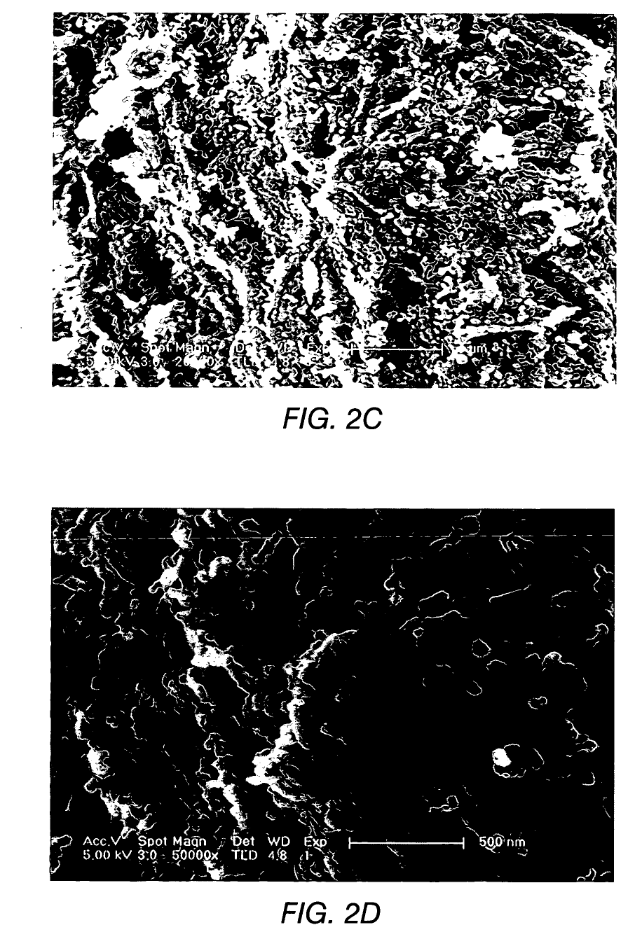

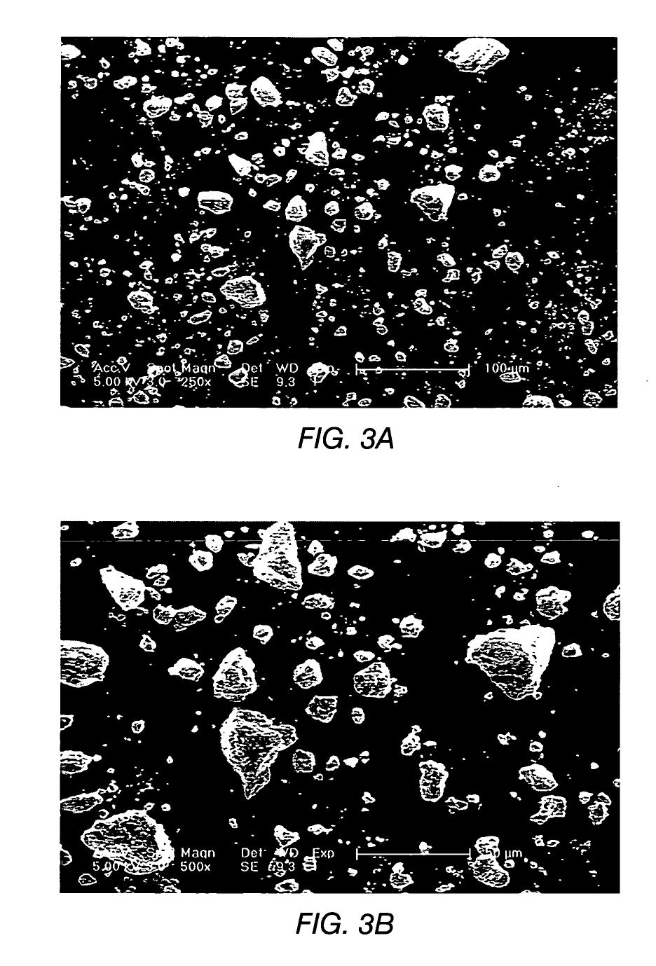

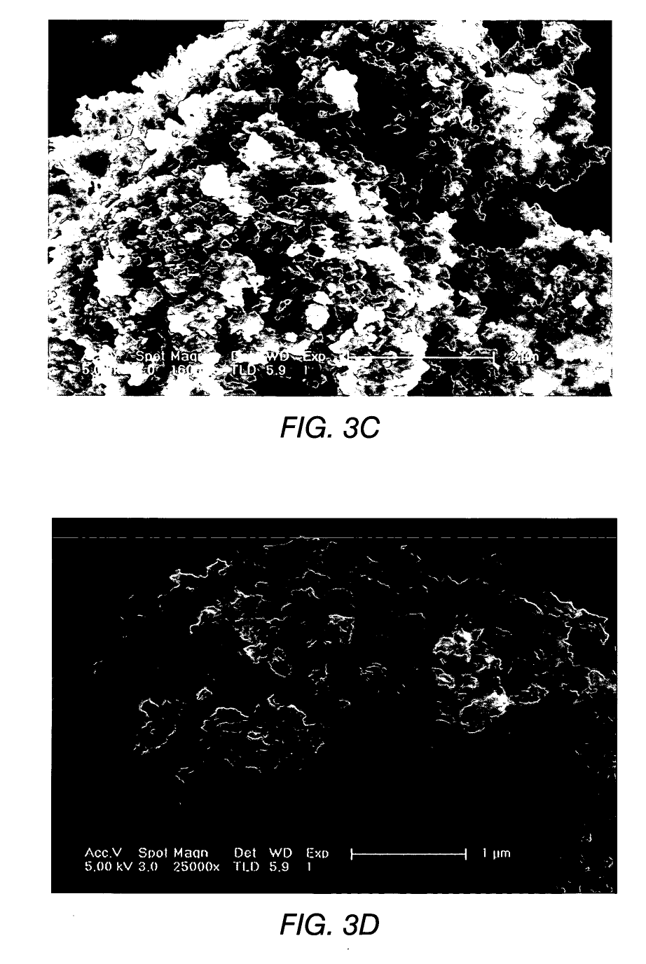

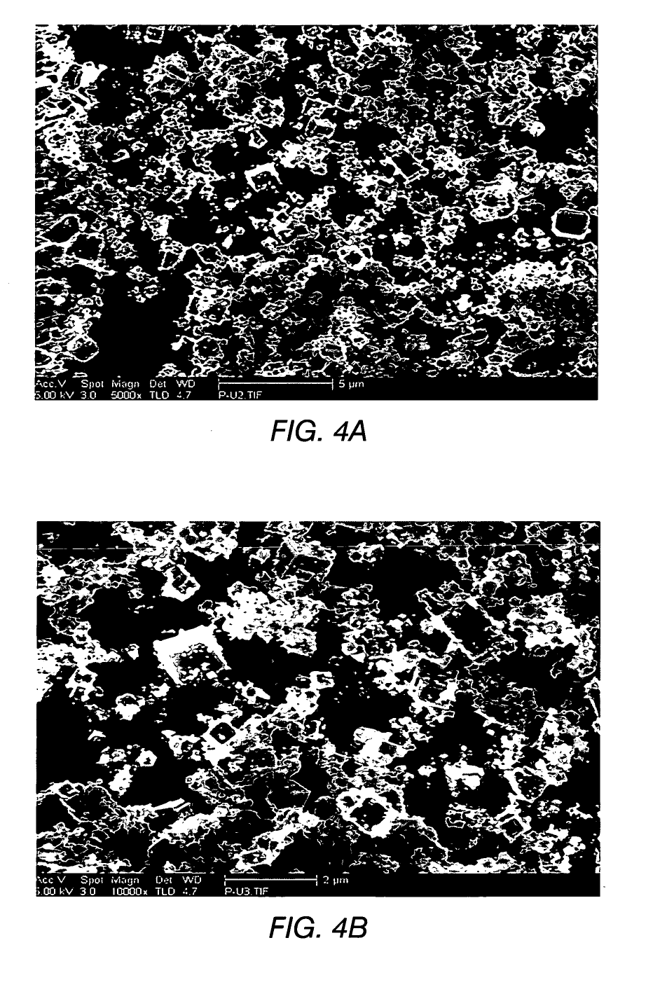

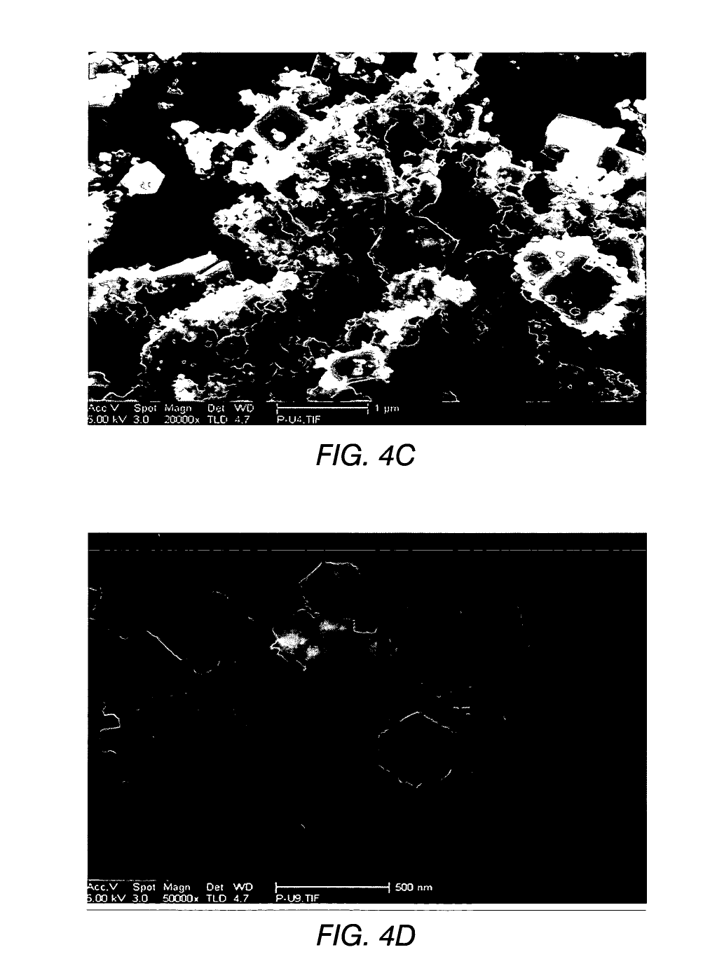

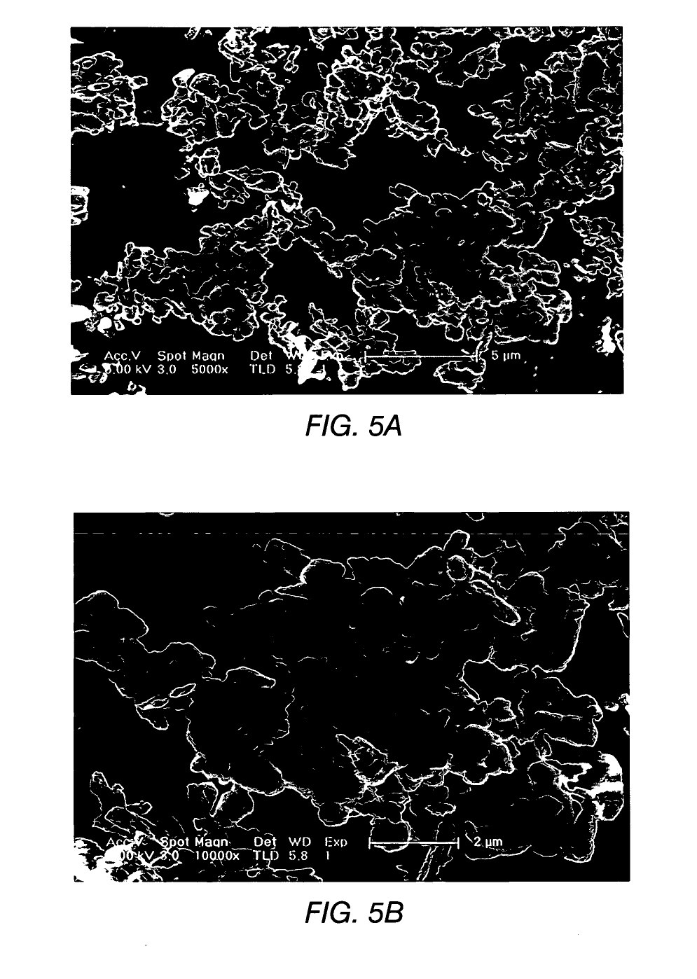

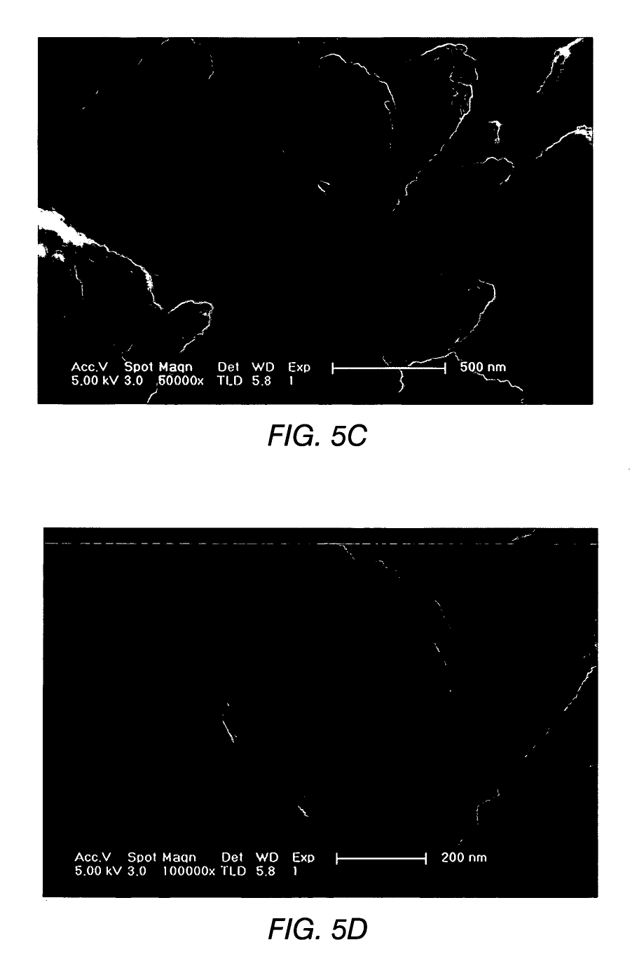

Magnesium oxide particles according to Examples 1 to 3 and Comparative Example 1 were examined with a scanning electron microscope (SEM). Scanning electron microscope photographs of the magnesium oxide particles according to Example 1 are provided in FIG. 2A (×1000), FIG. 2B (×5000), FIG. 2C (×20,000), and FIG. 2D (×50,000). Photographs of the magnesium oxide particles according to Example 2 are provided in FIG. 3A (×250), FIG. 3B (×500), FIG. 3C (×16,000), and FIG. 3D (×25,000). Photographs of the magnesium oxide particles according to Example 3 are provided in FIG. 4A (×5000), FIG. 4B (×10,000), FIG. 4C (×20,000), and FIG. 4D (×50,000). Photographs of the magnesium oxide particles according to Comparative Example 1 are provided in FIG. 5A (×5000), FIG. 5B (×10,000), FIG. 5C (×50,000), and FIG. 5D (×100,000).

Referring to FIGS. 2A to 2D, magnesium oxide particles of Example 1 were identified as polycrystalline particles having a diameter ranging from about 10 to about 20 μm.

In addition, referring to FIGS. 3A to 3D, magnesium oxide particles of Example 2 were identified as polycrystalline particles having a diameter from about 15 to about 35 μm.

Referring to FIGS. 4A to 4D, magnesium oxide particles of Example 3 were identified as monocrystalline particles having a diameter from about 50 to about 500 nm.

Referring to FIGS. 5A to 5D, magnesium oxide particles of Comparative Example 1 were identified as polycrystalline particles having a diameter of 1 μm.

Examination of the Prepared Sintered Magnesium Oxides with a Scanning Electron Microscope and Measurement of their Density

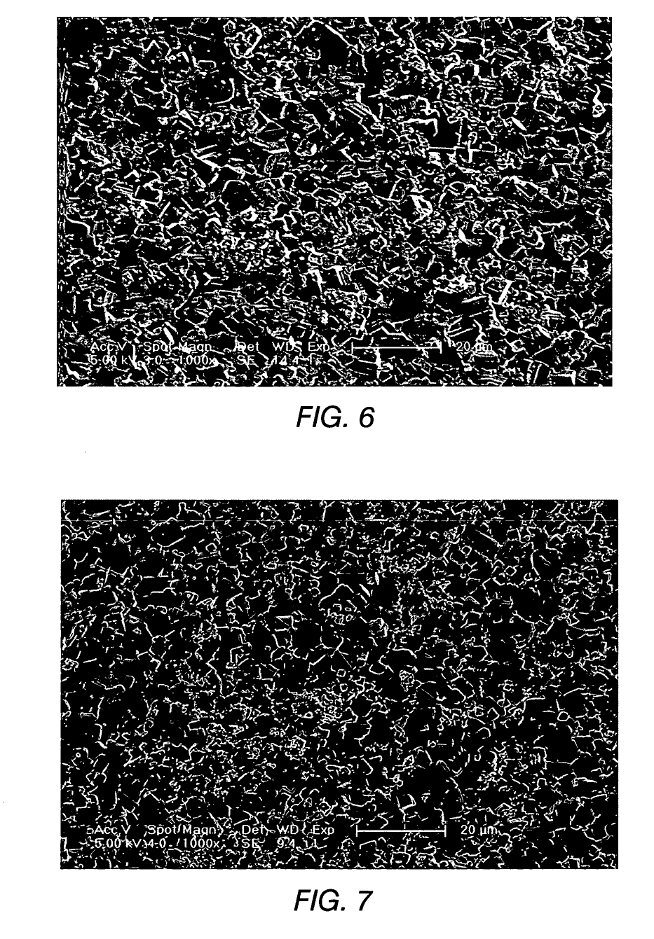

Sintered magnesium oxides prepared according to Examples 1 to 3 and Comparative Example 1 were examined with a scanning electron microscope (SEM). FIGS. 6 to 8 show the scanning electron microscope photographs of sintered magnesium oxides according to Examples 1 to 3. According to FIGS. 6 to 8, a straight line was drawn in a maximum length of each particle to measure an average size thereof. In addition, FIG. 9 shows the scanning electron microscope photograph of a sintered magnesium oxide according to Comparative Example 1.

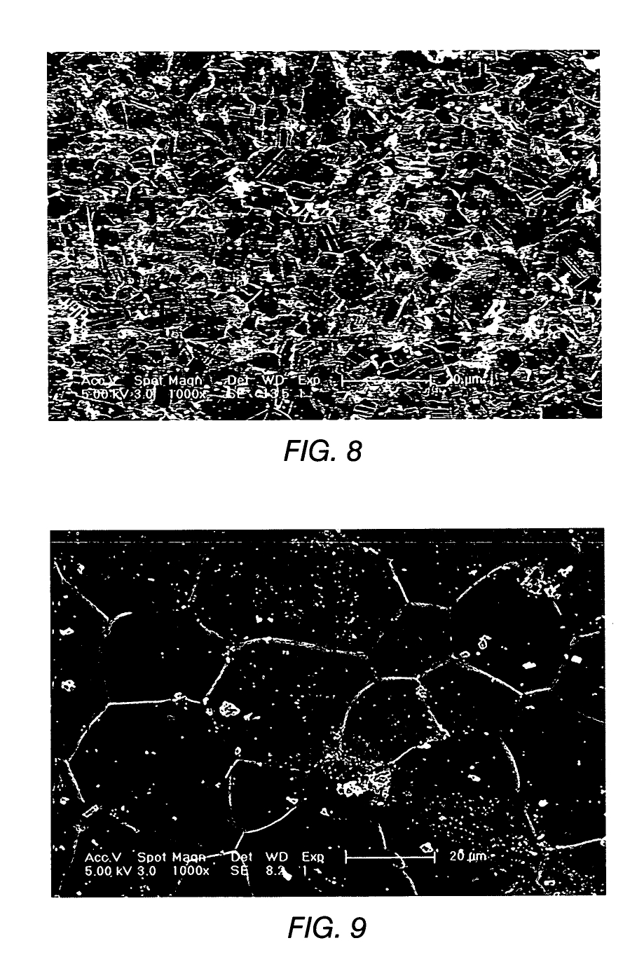

Referring to FIG. 6, the sintered magnesium oxide of Example 1 had an average size of 7.555 μm, while referring to FIG. 7, that of Example 2 had an average size of 4.487 μm. In addition, referring to FIG. 8, the sintered magnesium oxide of Example 3 had an average grain size of 4.287 μm, while referring to FIG. 9, that of Comparative Example 1 had an average grain size of 24.5 μm.

Furthermore, referring to FIGS. 6 to 9, the magnesium oxide particle shape remains on the surface of the sintered magnesium oxides prepared according to Examples 1 to 3. The magnesium oxide particles are still loose from one another, not accomplishing high density. However, the sintered magnesium oxide prepared according to Comparative Example 1 turned out to have high density among magnesium oxide particles, showing no remaining shape thereon.

The magnesium oxides prepared according to Examples 1 to 3 turned out to have densities ranging from 3.0 to 3.49 g/cm³, while that of Comparative Example 1 turned out to have a density of 3.5 g/cm³.

### Evaluation of Discharge Characteristics and Response Speed of the Prepared Plasma Display Panel (PDP)

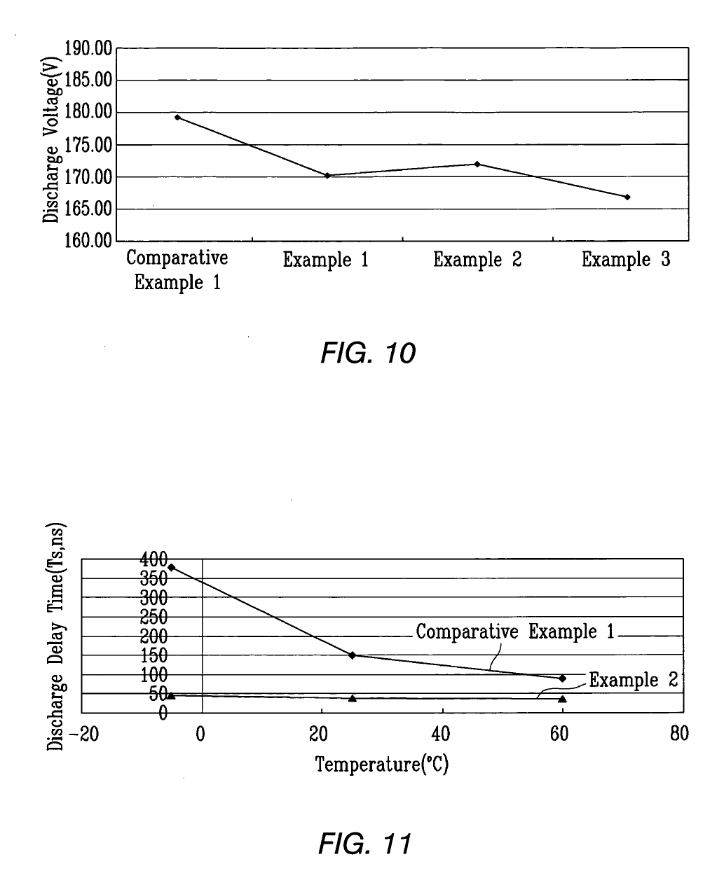

The prepared plasma display panels (PDP) were measured regarding discharge firing voltage. The results are provided in FIG. 10. Referring to FIG. 10, the plasma display panels (PDP) including sintered magnesium oxides of Examples 1 to 3 turned out to have lower discharge firing voltages than that of a plasma display panel (PDP) including a sintered magnesium oxide of Comparative Example 1.

Next, the plasma display panel (PDP) including sintered magnesium oxides of Examples 1 to 3 and Comparative Example 1 were measured regarding statistical delay time (Tₛ) change to check the response speed thereof. The results regarding the plasma display panels (PDP) including sintered magnesium oxides of Example 2 and Comparative Example 1 are provided in FIG. 11.

Referring to FIG. 11, the plasma display panel (PDP) including a sintered magnesium oxide of Example 2 showed a constant response speed even though its temperature was changed in a range of −10 to 60° C., accomplishing stable discharge characteristics. On the contrary, the plasma display panel (PDP) including a sintered magnesium oxide of Comparative Example 1 showed a sharply decreased response speed, not securing stable discharge characteristics. Further, the plasma display panels (PDP) including sintered magnesium oxides of Examples 1 and 3 showed similar statistical delay time changes to that of the plasma display panels (PDP) including sintered magnesium oxides of Example 2.

Therefore, a MgO protective layer made from the sintered magnesium oxide of the present embodiments can reduce a discharge voltage of a plasma display panel, improve its response speed, and provide high-purity film quality.

While these embodiments have been described in connection with what is presently considered to be practical exemplary embodiments, it is to be understood that the embodiments are not limited to the disclosed embodiments, but, on the contrary, is intended to cover various modifications and equivalent arrangements included within the spirit and scope of the appended claims.

What is claimed is:

1. A sintered magnesium oxide composition comprising magnesium oxide particles and having a density of less than 3.5 g/cm³, and an average grain size of from about 1 μm to about 12 μm.

2. The sintered magnesium oxide of claim 1, wherein the sintered magnesium oxide has an average grain size of about 3 μm to about 10 μm.

3. The sintered magnesium oxide of claim 1, wherein the sintered magnesium oxide has a density of about 3.0 to 3.49 g/cm³.

4. The sintered magnesium oxide of claim 1, wherein the magnesium oxide particles are polycrystalline magnesium oxide having a particle diameter of about 10 μm to about 35 μm.

5. The sintered magnesium oxide of claim 1, wherein the magnesium oxide particles are monocrystalline magnesium oxide having a particle diameter of about 50 to about 500 nm.

6. A plasma display panel comprising:
a first substrate and a second substrate facing each other;
a plurality of address electrodes disposed on the first substrate;
a plurality of display electrodes disposed on one side of the second substrate facing the first substrate in a direction crossing the address electrodes;
a phosphor layer disposed in the discharge spaces;
a MgO protective layer formed from a sintered magnesium oxide while covering the display electrodes;
a plurality of barrier ribs having a predetermined height from the first dielectric layer and disposed in a space between the first substrate and the second substrate to partition the space into discharge spaces of a predetermined size; and
a phosphor layer disposed in a discharge space,
wherein the sintered magnesium oxide comprises magnesium oxide particles, and has a density of less than 3.5 g/cm³ and an average grain size of about 1 to about 12 μm.

7. The plasma display panel of claim 6, wherein the sintered magnesium oxide has an average grain size of about 3 to about 10 μm.

8. The plasma display panel of claim 6, wherein the sintered magnesium oxide has a density of about 3.0 to 3.49 g/cm³.

9. The plasma display panel of claim 6, wherein the magnesium oxide particles are polycrystalline magnesium oxide having a particle diameter of about 10 μm to about 35 μm.

10. The plasma display panel of claim 6, wherein the magnesium oxide particles are monocrystalline magnesium oxide having a particle diameter of about 50 to about 500 nm.

11. The plasma display panel of claim 6, wherein the display electrode comprises indium tin oxide.

12. A method of preparing a sintered magnesium oxide comprising:
mixing and drying magnesium oxide particle powders;
compressing the powders to form a shape; and
growing crystals at a temperature from about 1600 to about 1700° C.

13. A method of making a plasma display panel comprising combining:
a first substrate and a second substrate, a plurality of address electrodes disposed on the first substrate, a plurality of display electrodes, a phosphor layer, and
an MgO protective layer formed from a sintered magnesium oxide while covering the display electrodes;
wherein the sintered magnesium oxide comprises magnesium oxide particles, and has a density of less than 3.5 g/cm³ and an average grain size of about 1 to about 12 μm.
